(19) United States
(12) Patent Application Publication
(10) Pub. No.: US 2026/0341552 A1
(43) Pub. Date: Oct. 29, 2026

(54) HIGHLY FLEXIBLE CONDUCTOR FOR CABLE

(71) Applicant: LS CABLE & SYSTEM LTD., Anyang-si, Gyeonggi-do (KR)

(72) Inventor: Hyun Su KIM, Dongjak-gu, Seoul (KR)

(21) Appl. No.: 19/114,584

(22) PCT Filed: Oct. 6, 2023
(86) PCT No.: PCT/KR2023/015449

§ 371 Date: Mar. 24, 2025

(30) Foreign Application Priority Data
Oct. 7, 2022 (KR) 10-2022-0128447
Oct. 4, 2023 (KR) 10-2023-0131663

(51) Int. Cl. H01B 7/00; H01B 1/02; H01B 7/04

(52) U.S. Cl. CPC H01B 7/0009; H01B 1/02; H01B 7/04

(57) ABSTRACT

This conductor for a cable is formed of a composite wire formed by twisting a plurality of collected wires formed by twisting a plurality of wires, and includes a central conductor including the collected wires and one or more outer conductor layers surrounding the outer circumference of the central conductor, wherein: aₙ is 0.5 to 1 (where, aₙ is the ratio of the collected pitch ratio of an n layer and an n+1 layer, that is, n layer collected pitch ratio/n+1 layer collected pitch ratio, n is an integer of 0 or greater, and 0 layer refers to the central conductor.); and bₙ satisfies 0.5 to 1 (where, bₙ is the ratio of the composite pitch ratio of an n layer and an n+1 layer, that is, n layer composite pitch ratio/n+1 layer composite pitch ratio, and n is an integer of 0 or greater).

### CROSS-REFERENCE TO RELATED APPLICATIONS

The present application is a National Stage of International Application No. PCT/KR2023/015449, filed on Oct. 6, 2023, which claims priority to Korean Application No. 10-2022-0128447, filed Oct. 7, 2022, and Korean Application No. 10-2023-0131663, filed Oct. 4, 2023, the entire contents of each hereby incorporated by reference.

### FIELD

The present disclosure relates to a highly flexible conductor for a cable, and more particularly, to a highly flexible conductor for a cable which satisfies basic electrical characteristics required as a conductor, inhibits excessive use of unnecessary conductors, and secures flexibility.

### BACKGROUND

Aluminum and aluminum alloy electric wires have mechanical/electrical characteristics which are different from those of copper electric wires, so that the application frequency thereof is increasing in specific areas. With respect to securing the required current of the conductor, since aluminum has an electrical conductivity of approximately 60% compared to that of copper, aluminum has to have a unit area of approximately 170% compared to copper. When the unit area of a conductor, or the outer diameter of a conductor is increased, the bending characteristics (Bending Rigidity, EI) or torsion characteristics (Reaction Torque) which traditionally is one of the measures of flexibility is increased, and, as a result, the flexibility of the finished product is reduced.

Since the flexibility of an electric wire is managed as an important property regardless of the product's application field, there follows many difficulties in the structural design of a conductor for an aluminum electric wire having increased outer diameter compared to an electric wire using copper conductor in terms of securing flexibility.

In general, in the case of using aluminum conductor, in order to secure flexibility of an electric wire, it is designed to make the thickness of a wire thinner, or to decrease the collected pitch ratio and composite pitch ratio. However, there is problems in that when the thickness of a wire is made to be thinner, the manufacturing cost for the product is increased, and when the collected pitch and composite pitch ratios are decreased, the resistance of the final product is increased, requiring the use of more conductors than necessary.

### SUMMARY

According to one embodiment of the present disclosure, the present disclosure aims to provide a highly flexible conductor for a cable which satisfies the basic electrical characteristics required as a conductor, inhibits excessive use of unnecessary conductors, and secures flexibility.

Among embodiments, a conductor for a cable according to one embodiment to realize the purpose of the present disclosure is formed of a composite wire formed by twisting a plurality of collected wires formed by twisting a plurality of wires, the conductor includes a central conductor including the collected wires and one or more outer conductor layers surrounding the outer circumference of the central conductor,
aₙ is 0.5 to 1 (where, aₙ is the ratio of the collected pitch ratio of an n layer and an n+1 layer, that is, n layer collected pitch ratio/n+1 layer collected pitch ratio, n is an integer of 0 or greater, and 0 layer refers to the central conductor), and bₙ satisfies 0.5 to 1 (where, bₙ is the ratio of the composite pitch ratio of an n layer and an n+1 layer, that is, n layer composite pitch ratio/n+1 layer composite pitch ratio, and n is an integer).

According to one embodiment of the present disclosure, the following mathematical expression may be satisfied.

1.2<aₙ+bₙ≤2.0 (where, aₙ is the ratio of the collected pitch ratio of an n layer and an n+1 layer, that is, n layer collected pitch ratio/n+1 layer collected pitch ratio, and bₙ is the ratio of the composite pitch ratio of an n layer and an n+1 layer, that is, n layer composite pitch ratio/n+1 layer composite pitch ratio)

According to one embodiment of the present disclosure, the collected pitch for each layer of the central conductor and the outer conductor layers may be 24 mm to 96 mm.

According to one embodiment of the present disclosure, the composite pitch for each layer of the central conductor and the outer conductor layers may be 65 mm to 465 mm.

According to one embodiment of the present disclosure, the diameter of a wire forming the collected wire may be 0.55 mm or less.

According to one embodiment of the present disclosure, the number of wires forming the collected wire may be 7 or greater.

According to one embodiment of the present disclosure, the wire forming the collected wire may include more than 99.7% aluminum (Al).

According to one embodiment of the present disclosure, the wire forming the collected wire may include aluminum (Al), silicon (Si), iron (Fe), copper (Cu), manganese (Mn), magnesium (Mg), chromium (Cr) and zinc (Zn).

According to one embodiment of the present disclosure, a conductor for a cable may minimize the use of conductor and raise the flexibility of the cable by adjusting the pitch ratio of a central conductor and an outer conductor layer surrounding the central conductor.

### BRIEF DESCRIPTION OF THE DRAWINGS

FIG. 1 is a diagram illustrating the concept of “pitch ratio” used from one embodiment of the present disclosure.

FIG. 2 is a diagram illustrating a conductor for a cable according to one embodiment of the present disclosure.

FIG. 3 is a diagram illustrating 3 point bending test equipment according to one embodiment of the present disclosure.

### DETAILED DESCRIPTION

Since the present disclosure may make various changes and have various embodiments, specific embodiments will be described in detail in the detailed description. However, this is not intended to limit the present disclosure to specific embodiments, and should be understood to include all modifications, equivalents, and substitutes included in the spirit and scope of the present disclosure. In describing each drawing, like reference numerals refer to like components. The terms such as first, second, etc. may be used to describe various components, but the components should not be limited by the above terms.

Such terms are used only for the purpose of distinguishing one component from another. Terms used from the present disclosure are used to describe a specific embodiment but are not intended to limit the present disclosure. A singular expression includes a plural expression unless there is clearly opposite meaning in the context.

In the present disclosure, it should be understood that terms such as “include” or “consist of” are intended to specify the existence of implemented features, numbers, steps, operations, components, parts, or combinations thereof described in the present disclosure, but should be understood as not precluding the possibility of the presence or addition of one or more other features, number, steps, operations, components, parts, or combinations thereof, in advance.

Unless otherwise contrarily defined, all terms used herein including technological or scientific terms have the same meanings as those generally understood by a person with ordinary skill in the art to which the present embodiments pertain. Terms which are defined in a generally used dictionary should be interpreted to have the same meaning as the meaning in the context of the related art, and are not interpreted as ideal or excessively formal meanings unless otherwise defined in the present disclosure.

Hereinafter, preferred embodiments of the present disclosure will be described in more detail with reference to the drawings.

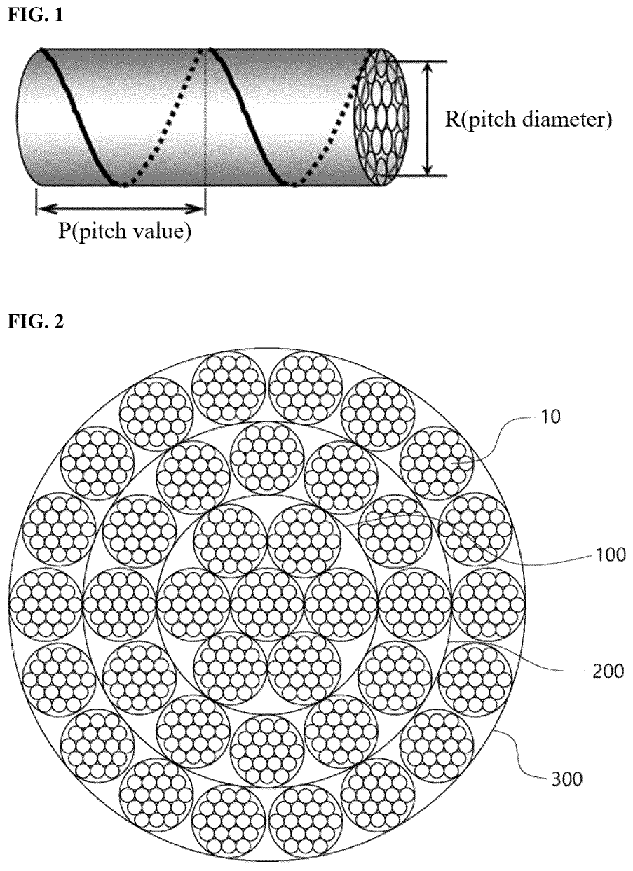

FIG. 1 is a diagram illustrating the concept of “pitch ratio” used from one embedment of the present disclosure.

Referring to FIG. 1, the term “pitch ratio” used from the present disclosure may be defined by the following mathematical expression 1.

pitch ratio=pitch value (mm)/pitch diameter (mm) Mathematical expression 1

Looking at the above mathematical expression 1, the above “pitch ratio” may mean the pitch value (mm) for the pitch diameter (mm). Here, “pitch diameter” means, in the case of collective wires, the diameter of an imaginary circle connecting the centers of the wires disposed in the outermost layer of the collective wires, and, in the case of composite wires, the diameter of an imaginary circle connecting the center of the collective wires disposed in the outermost layer of the collective wires. The collective wires refer to a form of conductors which are twisted into one direction after disposing a plurality of wires in parallel, where the wires have the same cross sectional area each other and the area of the collective wires is equal to the sum of the cross sectional areas cut perpendicular to the twisted angle of each wire. In addition, the composite wires refer to a form of conductors which are twisted into one direction after disposing a plurality of collective wires in parallel, where the area of the composite wires is equal to the sum of the cross sectional areas cut perpendicular to the twisted angle of each wire which comprises the collective wires. And thus, the term “collective wires pitch ratio”, which is described later, may be defined by the collective pitch value (mm) for the collective wires pitch diameter (mm), and the term “the composite wires pitch ratio” may be defined by the composite pitch value (mm) for the composite wires pitch diameter (mm). In addition, when the above conductors form a plurality of layers, in the case of the first layer, “the composite pitch ratio” of the corresponding layer may be defined by the composite pitch value for the composite wires pitch diameter (mm) of the first layer, and in the case of the second layer, “the composite pitch ratio” of the second layer may be defined by the composite pitch value for the composite wires pitch diameter (mm) of the second layer.

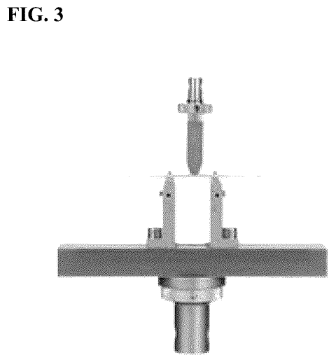

FIG. 2 is a diagram illustrating a conductor for a cable according to one embodiment of the present disclosure.

Referring to FIG. 2, a conductor for a cable according to one embodiment of the present disclosure may be formed of a plurality of layers.

The conductor for a cable according to one embodiment of the present disclosure may be formed by combining a plurality of wires 10 with a diameter 0.55 mm or less into a plurality of layers, and for example, the conductor for a cable may include a first composite layer 100 which is formed by a plurality of collective conductors disposed around a centrally located collective conductor, a second composite layer 200 which is formed by a plurality of collective conductors disposed around the first composite layer 100, and a third composite layer 300 which is formed by a plurality of collective conductors disposed around the second collective layer 200.

Here, a plurality of wires 10 included in the collective conductors are twisted each other at a predetermined collective pitch, and the collective conductors included in each of the plurality of collective layers are twisted each other at a different composite pitch by layers.

The conductor for a cable according to one embodiment of the present disclosure may be formed of collective wires by twisting a plurality of wires. In addition, the collective wires may form composite wires by twisting each other.

The conductor for a cable may form one or more outer conductive layers surrounding the outer circumference of the central conductor. FIG. 2 illustrates a structure formed in two layers which are formed with a central conductor and formed surrounding the outer circumference of the central conductor.

A conductor for a cable according to one embodiment of the present disclosure may include a central conductor including collective wires and one or more outer conductive layers surrounding the outer circumference of the central conductor.

Here, aₙ may be 0.5 to 1. Here, aₙ is the ratio of the collected pitch ratio of an n layer and an n+1 layer, that is, n layer collected pitch ratio/n+1 layer collected pitch ratio, n is an integer of 0 or greater, and 0 layer refers to the central conductor. In addition, bₙ may be 0.5 to 1. Here, bₙ is the ratio of the composite pitch ratio of an n layer and an n+1 layer, that is, n layer composite pitch ratio/n+1 layer composite pitch ratio, and n is an integer.

For example, the ratio of the collective pitch ratio of the central conductor and a first outer conductor layer directly surrounding the central conductor may be 0.5:1 to 1:1. That is, the collective pitch ratio of the central conductor may be formed more than 0.5 times and less than 1 time of the collective pitch ratio of the first outer conductive layer. In addition, the ratio of the collective pitch ratio of the first layer and the collective pitch ratio of the second layer surrounding the first outer conductive layer may be 0.5:1 to 1:1. That is, the collective pitch ratio of the first layer may be formed more than 0.5 times and not greater than 1 time.

In addition, the conductor for a cable according to one embodiment of the present disclosure may satisfy mathematics expression 2 below.

1.2<aₙ+bₙ≤2.0 Mathematical expression 2

Here, aₙ is the ratio of the collected pitch ratio of an n layer and an n+1 layer, that is, n layer collected pitch ratio/n+1 layer collected pitch ratio, and bₙ is the ratio of the composite pitch ratio of an n layer and an n+1 layer, that is, n layer composite pitch ratio/n+1 layer composite pitch ratio.

In addition, the collected pitch for each layer of the central conductor and the outer conductor layers may be formed as 24 mm to 96 mm, and the composite pitch ratio for each layer of the central conductor and the outer conductor layers may be formed as 65 mm to 465 mm.

The central conductor is formed of collective wires formed by twisting a plurality of wires, and the outer conductor layers may be formed twisting a plurality of collected wires formed by twisting a plurality of wires. The diameter of wires that form the collected wires may be 0.55 mm or less.

In addition, the number of wires forming the collected wire may be 7 or greater. For example, when the collected wires are formed with 7 wires, the collected wires may have a structure in which 7 strains are disposed surrounding 1 central strain.

A conductor for a cable has a property in which the characteristics of a conductor are determined by the pitch ratio, regardless of the conductor diameter that forms the conductor. Thus, the conductor for a cable according to one embodiment of the present disclosure is characterized by the conditions related to “pitch ratio”. From the present disclosure, collected pitch and composite pitch values are limited. The diameter of a wire which forms a collected wire is limited to 0.55 mm or less. However, when the diameter of a wire is reduced, there is a problem that the manufacturing cost increases, and thus, considering economic issues, this is to ensure that the diameter of a wire which forms a collected wire is greater than a predetermined value. Thus, collected pitch and composite pitch are limited so that the diameter of a wire is not designed to be less than a predetermined value.

The wire forming the collected wire may include more than 99.7% aluminum (Al).

In addition, the wire forming the collected wire may include aluminum (Al), silicon (Si), iron (Fe), copper (Cu), manganese (Mn), magnesium (Mg), chromium (Cr) and zinc (Zn), and the total sum of the remaining materials excluding aluminum may be included at a ratio of 2% or less.

### Embodiment

### Manufacturing Example

A conductor for a cable is manufactured according to a configuration described in Tables 1 to 3 below.

TABLE 1

| | Number of | Composite structure | | | |
|---|---|---|---|---|---|
| | collected | | 1^{st} | 2^{nd} | 3^{rd} |
| | wires | Center | layer | layer | layer |
| Embodiment 1 | 13 | 1 | 6 | 12 | |
| Embodiment 2 | 25 | 1 | 6 | 12 | |
| Embodiment 3 | 13 | 1 | 6 | 12 | |
| Embodiment 4 | 13 | 1 | 6 | 12 | |
| Embodiment 5 | 7 | 1 | 6 | 12 | 18 |
| Embodiment 6 | 7 | 1 | 6 | 12 | 18 |
| Comparative | 13 | 1 | 6 | 12 | |
| example 1 | | | | | |
| Comparative | 13 | 1 | 6 | 12 | |
| example 2 | | | | | |
| Comparative | 13 | 1 | 6 | 12 | |
| example 3 | | | | | |
| Comparative | 13 | 1 | 6 | 12 | |
| example 4 | | | | | |
| Comparative | 13 | 1 | 6 | 12 | |
| example 5 | | | | | |
| Comparative | 13 | 1 | 6 | 12 | |
| example 6 | | | | | |

TABLE 2

| | Collected pitch ratio | | | | Composite pitch ratio | | |
|---|---|---|---|---|---|---|---|
| | | 1^{st} | 2^{nd} | 3^{rd} | 1^{st} | 2^{nd} | 3^{rd} |
| Pitch ratio | Center | layer | layer | layer | layer | layer | layer |
| Embodiment 1 | 18 | 18 | 29 | | 15 | 17 | |
| Embodiment 2 | 18 | 18 | 29 | | 15 | 17 | |
| Embodiment 3 | 12 | 15 | 18 | | 15 | 17 | |
| Embodiment 4 | 18 | 18 | 24 | | 11 | 16 | |
| Embodiment 5 | 18 | 24 | 30 | 34 | 15 | 17 | 19 |
| Embodiment 6 | 18 | 24 | 30 | 34 | 15 | 17 | 24 |
| Comparative | 11 | 25 | 25 | | 15 | 17 | |
| example 1 | | | | | | | |
| Comparative | 11 | 10 | 15 | | 10 | 17 | |
| example 2 | | | | | | | |
| Comparative | 18 | 18 | 24 | | 10 | 23 | |
| example 3 | | | | | | | |
| Comparative | 18 | 18 | 24 | | 15 | 14 | |
| example 4 | | | | | | | |
| Comparative | 12 | 12 | 30 | | 10 | 20 | |
| example 5 | | | | | | | |
| Comparative | 18 | 18 | 18 | | 10 | 9 | |
| example 6 | | | | | | | |

TABLE 3

| | Ratio of the pitch ratio | | | | | | |
|---|---|---|---|---|---|---|---|
| | | | | | | aₙ + bₙ | |
| | Ratio of the | | | Ratio of the | | collected/ | |
| | collected pitch | | | composite pitch | | composite | |
| | ratio for each | | | ratio for each | | ratio | |
| | layer aₙ | | | layer bₙ | | a₁ + | a₂ + |
| | a₀ | a₁ | a₂ | b₁ | b₂ | b₁ | b₂ |
| Embodiment 1 | 1.0 | 0.6 | | 0.9 | | 1.5 | |
| Embodiment 2 | 1.0 | 0.6 | | 0.9 | | 1.5 | |
| Embodiment 3 | 0.8 | 0.8 | | 0.9 | | 1.7 | |
| Embodiment 4 | 1.0 | 0.8 | | 0.7 | | 1.5 | |
| Embodiment 5 | 0.8 | 0.8 | 0.9 | 0.9 | 0.9 | 1.7 | 1.8 |
| Embodiment 6 | 0.8 | 0.8 | 0.9 | 0.9 | 0.7 | 1.7 | 1.6 |
| Comparative example 1 | 0.4 | 1.0 | | 0.9 | | 1.9 | |
| Comparative example 2 | 1.1 | 0.7 | | 0.6 | | 1.3 | |
| Comparative example 3 | 1.0 | 0.8 | | 0.4 | | 1.2 | |
| Comparative example 4 | 1.0 | 0.8 | | 1.1 | | 1.9 | |
| Comparative example 5 | 1.0 | 0.4 | | 0.5 | | 0.9 | |
| Comparative example 6 | 1.0 | 1.0 | | 1.1 | | 2.1 | |

### 2. Property Evaluation

### 1) Flexibility Evaluation

For each conductor of Embodiments and Comparative examples, reaction torque and bending rigidity are measured through 3 point bending test to perform a relative comparison evaluation.

The conductor for a cable which is used as a control group for the flexibility test is a conductor that satisfies the same target resistance to the conductor proposed from Embodiments and Comparative examples, has the same type of wire, and has the same layer ratio with arbitrarily defined composite pitch ratio for each layer. Since the pitch ratio of the conductor is set the same, when the target resistance is not satisfied, the number of wires forming a collective wire is increased. FIG. 3 illustrates an equipment for 3 point bend test. For jigs and test methods needed for 3 point bening test, conditions that fit the diameter of the conductor are selected by referring to ASTM E290.

TABLE 4

| Flexibility evaluation | Bending rigidity (N) | Result |
|---|---|---|
| Embodiment 1 | 147 | success |
| Embodiment 2 | 140 | success |
| Embodiment 3 | 136 | success |
| Embodiment 4 | 153 | success |
| Embodiment 5 | 150 | success |
| Embodiment 6 | 158 | failure |
| Comparative example 1 | 186 | failure |
| Comparative example 2 | 166 | failure |
| Comparative example 3 | 171 | failure |
| Comparative example 4 | 162 | failure |
| Comparative example 5 | 184 | failure |
| Comparative example 6 | 162 | failure |

As is summarized from the above Table 4, the conductors for a cable from Embodiments 1 to 6 according to embodiments of the present disclosure having a bending rigidity less than 160 N satisfy the flexibility evaluation criteria, whereas the conductors for a cable from Comparative examples 1 to 6 having bending rigidity exceeding 160 N do not satisfy the flexibility evaluation criteria.

### 2) Conductor Overload Evaluation

For each conductor from Embodiments and Comparative examples, when a single wire conductor having the maximum resistance that satisfies the specification has a weight that is 10% or more than the unit weight, the conductor is evaluated as an overloaded conductor.

### 3) Shape Stability Evaluation

Shape stability is an emotional evaluation which determines whether the macroscopic shape of the conductor maintains a circular shape. Normally, wires are processed with taping or an insulating process on the conductor. When the shape of conductors is not stable, there are occasions that the surfaces thereof are bumpy or an insulating process itself fails. The shape stability evaluation is determined by the presence or absence of conductor traces on the exterior of the wire after taping or insulating process. That is, when a twisted trace of a conductor is clearly observable with the naked eye on the exterior of the wire after taping or insulation, or when a workability is not secured, it is determined that the shape stability is deficient.

The above property evaluation results are described in Table 5 below.

TABLE 5

| | | Conductor | Conductor |
|---|---|---|---|
| Bad cause | Flexibility | overload | formation |
| Embodiment 1 | good | good | good |
| Embodiment 2 | good | good | good |
| Embodiment 3 | good | good | good |
| Embodiment 4 | good | good | good |
| Embodiment 5 | good | good | good |
| Embodiment 6 | good | good | good |
| Comparative example | bad | good | good |
| 1 | | | |
| Comparative example | good | bad | good |
| 2 | | | |
| Comparative example | good | good | bad |
| 3 | | | |
| Comparative example | good | bad | good |
| 4 | | | |
| Comparative example | bad | good | good |
| 5 | | | |
| Comparative example | good | bad | good |
| 6 | | | |

As is summarized from the above Table 5, it is confirmed that the conductor for a cable from Embodiments 1 to 6 according to embodiments of the present disclosure simultaneously implements, through composite pitch and collected pitch for layers which are precisely controlled, excellent flexibility and conductor overload prohibition which are mutually conflicting, and shape stability is excellent.

In the meantime, Comparative example 1 has a problem in which flexibility is significantly reduced because the lower limit ratio among the ratios per collective layer is below the reference value (a₁ is 0.4, and reference value is 0.5 or greater). The conductor for a cable from Comparative example 2 has an issue in which conductor overload occurs because the upper limit ratio among the ratios per collective layer is above the reference value (a₁ is 1.1, and reference value is 1.0 or less).

It is confirmed that the conductor for a cable from Comparative example 3 has a lower shape stability of conductor formation because the lower limit ratio among the ratios per collective layer is below the reference value (b₁ is 0.4, and reference value is 0.5 or greater), and the conductor for a cable from Comparative example 4 has a problem in which conductor overload occurs because the upper limit ratio among the ratios per collective layer is above the reference value (b₁ is 1.1, and reference value is 1.0 or less).

In addition, the conductor for a cable from Comparative example 5 has a significantly low flexibility because the upper limit ratio among the ratios per collective layer is above the reference (a₁ is 1.1, and reference value is 1.0 or less) and collective/composite ratio is below the reference value (a₁+b₁=0.9, and reference value is greater than 1.2), and the conductor for a cable from Comparative example 6 has a problem in which conductor overload problem occurs significantly because the lower limit ratio among the ratios per collective layer is above the reference value (b₁ is 1.1, and reference value is 1.0 or less) and collective/composite ratio is also above the reference value (a₁+b₁=2.1, and reference value is less than 2.0).

As described above, although the present disclosure has been described above with reference to embodiments, it will be understood by those skilled in the art that various modifications and changes may be made to the present disclosure without departing from the spirit and scope of the present disclosure as set forth in the claims below.

1. A conductor for a cable which is formed of a composite wire formed by twisting a plurality of collected wires formed by twisting a plurality of wires, the conductor comprising:
a central conductor including the collected wire; and
one or more outer conductor layers surrounding the outer circumference of the central conductor, wherein
aₙ is 0.5 to 1 (where, aₙ is the ratio of the collected pitch ratio of an n layer and an n+1 layer, that is, n layer collected pitch ratio/n+1 layer collected pitch ratio, n is an integer of 0 or greater, and 0 layer refers to the central conductor), and
bₙ satisfies 0.5 to 1 (where, bₙ is the ratio of the composite pitch ratio of an n layer and an n+1 layer, that is, n layer composite pitch ratio/n+1 layer composite pitch ratio, and n is an integer).

2. The conductor for a cable of claim 1, wherein the conductor satisfies the following mathematical expression.
1.2<aₙ+bₙ≤2.0
(where, aₙ is the ratio of the collected pitch ratio of an n layer and an n+1 layer, that is, n layer collected pitch ratio/n+1 layer collected pitch ratio, and bₙ is the ratio of the composite pitch ratio of an n layer and an n+1 layer, that is, n layer composite pitch ratio/n+1 layer composite pitch ratio)

3. The conductor for a cable of claim 1, wherein the collected pitch for each layer of the central conductor and the outer conductor layers is 24 mm to 96 mm.

4. The conductor for a cable of claim 1, wherein the composite pitch for each layer of the central conductor and the outer conductor layers is 65 mm to 465 mm.

5. The conductor for a cable of claim 1, wherein the diameter of a wire forming the collected wire is 0.55 mm or less.

6. The conductor for a cable of claim 1, wherein the number of wires forming the collected wire is 7 or greater.

7. The conductor for a cable of claim 1, wherein the wire forming the collected wire includes more than 99.7% aluminum (Al).

8. The conductor for a cable of claim 1, wherein the wire forming the collected wire includes aluminum (Al), silicon (Si), iron (Fe), copper (Cu), manganese (Mn), magnesium (Mg), chromium (Cr) and zinc (Zn).
